(19) United States
(12) Patent Application Publication
(10) Pub. No.: US 2011/0302574 A1
(43) Pub. Date: Dec. 8, 2011

(54) UPDATE MANAGEMENT SERVER, ELECTRONIC APPARATUS, UPDATE MANAGEMENT SYSTEM, AND METHOD THEREFOR

(75) Inventor: Kiyoshi YOSHIKAWA, Saitama (JP)

(73) Assignee: Sony Corporation, Tokyo (JP)

(21) Appl. No.: 13/106,157

(22) Filed: May 12, 2011

(30) Foreign Application Priority Data
Jun. 8, 2010 (JP) 2010-131385

(51) Int. Cl. G06F 9/44

(52) U.S. Cl. 717/173

(57) ABSTRACT

A first electronic apparatus fails to have specifications enough to display contents of a license agreement for new-agreement software, the new-agreement software being update-version software of software that the first electronic apparatus has and being target software requiring the license agreement of a user of the first electronic apparatus. In an update management server, a controller causes a communication section to transmit, in a case where a first determining section determines that a version corresponding to an apparatus identification information is a version previous to a version of the new-agreement software, content information on the license agreement corresponding to the new-agreement software to a second electronic apparatus owned by the user who owns the first electronic apparatus, the second electronic apparatus having specifications enough to display contents of the license agreement and being connectable to a network, based on user identification information corresponding to the apparatus identification information.

### BACKGROUND

The present disclosure relates to an update management server managing update of software embedded in an electronic apparatus having no display unit or merely having a simple (poor) display unit, the electronic apparatus, an update management system including them, and a method for managing the update.

There has been established a system in which, in a case of updating a program of software of an electronic apparatus such as a PC (Personal Computer), a mobile phone, or the like, a server storing the update-version software provides a program to the electronic apparatus via a network. In general, in a case where a server provides a program, the server also provides a license agreement such as an EULA (End User License Agreement) via a network. Then, an electronic apparatus displays contents of the license agreement on a display unit that the electronic apparatus has, whereby a user confirms the contents and an agreement for use of the software is concluded.

For example, Japanese Patent Application Laid-open No. 3385590 (hereinafter referred to as Patent Document 1) discloses the following system. That is, according to this system, once a user having a computer system signs up for an agreement for contents of a license agreement for software firstly, then the server system automatically performs provision to the computer system owned by the user via a network without such a license agreement (for example, see Patent Document 1).

However, according to the system of Patent Document 1, since software is automatically updated without a license agreement, if software to be updated is software whose contents are beyond the scope of contents of the first license agreement, the software may not be updated.

To the contrary, in a system in which such software is updated without a license agreement, there is a fear that problems in agreement or legal problems may occur.

If an update-target apparatus is an electronic apparatus having a display unit capable of displaying contents of a license agreement, such problems may not occur even in the system of Patent Document 1. That is, even in a case where a software program to be updated is a program whose contents are beyond the scope of contents of a previous (for example, first) license agreement, the target electronic apparatus may display license agreement contents of the program to be updated on the display unit.

However, in a case where an electronic apparatus having no display unit or an electronic apparatus merely having a simple display unit such as a pedometer, a stopwatch, or the like is an update-target apparatus, since such an electronic apparatus is incapable of displaying license agreement contents, update may not be completed. Alternatively, even in a case where update is completed, there is a fear that problems in agreement may occur.

### SUMMARY

In view of the above-mentioned circumstances, it is desirable to provide an update management server capable of causing an electronic apparatus having no display unit or merely having a simple display unit to update software requiring a license agreement including contents beyond the scope of contents of a previous license agreement, an electronic apparatus being the update target, an update management system, and a method therefor.

It is also desirable to provide a technology of an update management server and the like capable of requiring, even in a case where an owner of an update-target electronic apparatus is changed, a license agreement for a program to be updated of an owner after the change.

According to an embodiment of the present disclosure, there is provided an update management server including a storage, a communication section, a first determining section, and a controller.

The storage is configured to store apparatus identification information uniquely identifying a first electronic apparatus failing to have specifications enough to display contents of a license agreement for new-agreement software, the new-agreement software being update-version software of software that the first electronic apparatus has and being target software requiring the license agreement of a user of the first electronic apparatus, version information on the software that the first electronic apparatus has, and user identification information uniquely identifying the user in relation to each other. Further, the storage is configured to store the new-agreement software and content information on the license agreement for the new-agreement software in relation to each other.

The communication section is capable of receiving the apparatus identification information on the first electronic apparatus via a network.

The first determining section is configured to determine whether the version corresponding to the received apparatus identification information is a version previous to the new-agreement software.

The controller is configured to perform the following processing in a case where the first determining section determines that the version corresponding to the apparatus identification information is a version previous to a version of the new-agreement software. That is, the controller causes the communication section to transmit content information on the license agreement corresponding to the new-agreement software to a second electronic apparatus owned by the user who owns the first electronic apparatus, the second electronic apparatus having specifications enough to display contents of the license agreement and being connectable to the network, based on the user identification information corresponding to the apparatus identification information. Further, the controller is configured to cause the communication section to transmit, in a case where the license agreement establishes, the new-agreement software to the first electronic apparatus having the received apparatus identification information.

According to the present disclosure, an update target is software that an electronic apparatus failing to have specifications enough to display contents of a license agreement, that is, an electronic apparatus merely having a simple display unit (first electronic apparatus) has. It is difficult for the first electronic apparatus merely having a simple display unit to display content information on a license agreement on the display unit enough. Therefore, according to the present disclosure, in a case where a version of software that the first electronic apparatus has presently which was received by the first electronic apparatus via a network is a version previous to a version of new-agreement software, a controller transmits content information on a license agreement to a second electronic apparatus having specifications enough to display information. New-agreement software is software requiring a license agreement of a user, that is, software requiring a license agreement including contents beyond the scope of contents of a previous license agreement. In a case where a user agrees on contents of the license agreement displayed on the second electronic apparatus, the controller transmits new-agreement software to the first electronic apparatus. The first electronic apparatus installs the new-agreement software, to thereby update software.

Therefore, a first electronic apparatus merely having a simple display unit may update software including contents beyond the scope of contents of a previous license agreement. Therefore, there is no fear that problems in agreement occur.

The new-agreement software being update-version software of software that the first electronic apparatus has and being target software requiring the license agreement of a user is, as described above, software requiring a license agreement including contents beyond the scope of contents of a previous license agreement.

“The new-agreement software and content information on the license agreement for the new-agreement software in relation to each other” also means a case where identification information identifying new-agreement software and identification information identifying its license agreement content information are in relation to each other.

The update management server may further include a second determining section configured to determine whether contents of a license agreement for the update-version software are within the scope of contents of a license agreement for software of the version corresponding to the apparatus identification information received by the communication section. Further, the controller is configured to cause the communication section to transmit, in a case where the second determining section determines that contents of a license agreement for the update-version software are within the scope of contents of a license agreement for software of the version corresponding to the apparatus identification information, the update-version software without a license agreement to the first electronic apparatus.

That is, the update management server may determine whether the update-version software requires a license agreement or not. Therefore, in a case where the update-version software is latter (which does not require a license agreement), the update management server may transmit the software to the first electronic apparatus and causing the first electronic apparatus to automatically update without a license agreement.

The update management server may further include an update section configured to update, in a case where an owner of the first electronic apparatus is changed from the user to another user, the user information.

In this case, the first determining section is configured to determine, in a case where the communication section receives the apparatus identification information after the update section updates the user information, whether the version corresponding to the received apparatus identification information and a version previous to the version include a version of the new-agreement software being a target requiring the license agreement.

Further, the controller is configured to perform the following processing in a case where the first determining section determines that a version corresponding to the apparatus identification information and a version previous to the version include a version of the new-agreement software. That is, the controller causes the communication section to transmit content information on the license agreement relating to at least one piece of the new-agreement software of software of the version corresponding to the apparatus identification information and the previous version to a third electronic apparatus owned by the other user, the third electronic apparatus having specifications enough to display contents of the license agreement and being connectable to the network, based on the user identification information on the other user corresponding to the apparatus identification information.

Further, the controller is configured to cause the communication section to transmit, in a case where the transmitted license agreement fails to establish, a signal limiting functions of the new-agreement software of the license agreement failed to establish to the first electronic apparatus.

The third electronic apparatus is similar to the above-mentioned second electronic apparatus.

In the past, a license agreement for software embedded in an electronic apparatus of a user was performed only of the user. So, in a case of ownership change, there was a fear that problems in agreement might occur when the latest user used the software after the ownership change. However, according to the present disclosure, in a case of ownership change of an owner of the first electronic apparatus, in a case where target new-agreement software requiring a license agreement was installed into the first electronic apparatus before the ownership change, the license agreement may be required of a user after the ownership change. In a case where a license agreement establishes, the user may use the first electronic apparatus as it is. To the contrary, in a case where a license agreement fails to establish, a signal limiting (part or all of) functions of the new-agreement software already installed into the electronic apparatus is transmitted. Therefore, due to the signal, a user may not use (part or all of) functions of the new-agreement software in the first electronic apparatus.

Therefore, even in a case where an owner of the first electronic apparatus is changed, there is no fear that problems in agreement occur.

An electronic apparatus according to the present disclosure is an electronic apparatus failing to have specifications enough to display contents of a license agreement for new-agreement software, the new-agreement software being update-version software of software that the electronic apparatus has and being target software requiring the license agreement of a user of the electronic apparatus, the electronic apparatus being connectable to a network.

The electronic apparatus includes a transmitter, a receiver, and an install unit.

The transmitter is configured to transmit the apparatus identification information on the electronic apparatus to the above-mentioned update management server via the network.

The receiver is configured to perform the following processing in a case where the update management server determines that the version corresponding to the apparatus identification information received by the update management server is a version previous to the new-agreement software. That is, the receiver receives, in a case where the update management server transmits content information on the license agreement corresponding to the new-agreement software to another electronic apparatus via the network based on the user identification information corresponding to the apparatus identification information, and the license agreement establishes, the new-agreement software transmitted by the update management server via the network.

The other electronic apparatus is similar to the above-mentioned second or third electronic apparatus.

The install unit is configured to install the new-agreement software received by the receiver on the electronic apparatus.

It is difficult for an electronic apparatus merely having a simple display unit to display content information on a license agreement on the display unit enough. Therefore, according to the present disclosure, in a case where a version of software that an electronic apparatus has presently is a version previous to a version of a new-agreement software, the update management server transmits content information on a license agreement to another electronic apparatus having specifications capable of displaying information enough.

In a case where a user agrees on contents of the license agreement displayed on the other electronic apparatus, the update management server transmits new-agreement software to the electronic apparatus. The electronic apparatus installs the new-agreement software, to thereby update software.

Therefore, an electronic apparatus merely having a simple display unit may update software requiring a license agreement including contents beyond the scope of contents of a previous license agreement. Therefore, there is no fear that problems in agreement occur.

As described above, according to the present disclosure, an electronic apparatus having no display unit or merely having a simple display unit may update software requiring a license agreement including contents beyond the scope of contents of a previous license agreement. Further, according to the present disclosure, even in a case where an owner of an update-target electronic apparatus is changed, a license agreement for a program to be updated may be required of an owner after the change.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a structure of an update management system of software according to an embodiment of the present disclosure;

FIG. 2 is a diagram showing a functional block of an update management server;

FIG. 3 shows an example of a user information table implementing a user information processing block and stored in a storage device (not shown) of the update management server;

FIG. 4 shows an example of an update information table implementing an update information processing block and stored in a storage device of the update management server;

FIG. 5 is a flowchart showing an operation of the update management system; and

FIG. 6 is a flowchart showing an operation of the update management system according to a second embodiment.

### DETAILED DESCRIPTION OF EMBODIMENTS

Hereinafter, embodiments of the present disclosure will be described with reference to the drawings.

### First Embodiment

(Structure of Update Management System)

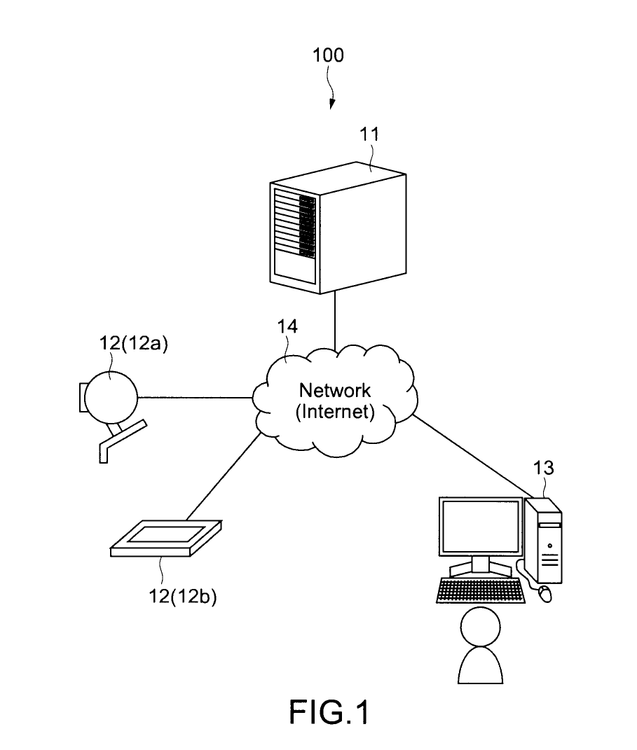

FIG. 1 is a diagram showing a structure of an update management system 100 of software according to an embodiment of the present disclosure.

The update management system 100 includes an update management server 11, electronic apparatuses 12 each being an update target of software, a PC 13 owned by a user who owns the electronic apparatus 12. A network 14 is, for example, the Internet using TCP/IP (Transmission Control Protocol/Internet Protocol) or the like.

Examples of the electronic apparatuses 12 include, for example, a network camera 12a as an apparatus having no display unit, and, for example, a pedometer 12b and the like as an apparatus merely having a simple display unit. Those electronic apparatuses 12 are configured to be connectable to the network 14. Each electronic apparatus 12 includes software. The software includes application software, firmware, or an OS (Operating System).

The electronic apparatus merely having a simple display unit, that is, an electronic apparatus not having specifications enough to display contents of a license agreement (described later) is, for example, an electronic apparatus to which an input operation by a user to scroll a screen displayed on the display unit is not allowed. In other words, it is difficult for a user to purposely scroll a screen displayed on a display unit through an operation of the electronic apparatus 12. In such an electronic apparatus, it is difficult to display all the content information on a license agreement for software on the display unit (described later). Further, an electronic apparatus merely having a simple display unit also means an electronic apparatus having a small display unit allowing screen scrolling through a user operation, with which it is difficult for a user to recognize the contents or a user is reluctant to recognize the contents.

Specific examples of a simple display unit includes, for example, a display unit capable of merely displaying a text of about one line to four lines and a display unit whose size (length of diagonal line) is equal to or less than about 3 cm. Although not applied to those conditions, most of display units of electronic apparatuses not having functions which allows a user to purposely scroll a screen displayed on a display unit through an operation of the electronic apparatus as described above are simple display units. Further, in a case where the electronic apparatus 12 merely has functions to scroll a screen on a display unit irrespective of an input operation by a user as scroll functions, a display unit of the electronic apparatus 12 is a simple display unit.

The PC 13 includes a display unit different from the above-mentioned simple display unit. That is, the display unit of the PC 13 is a display unit of an apparatus having scrolling functions through an input operation by a user.

Note that, scrolling is processing to display display information on a text, an image, or the like, which may not be displayed on an area of a screen of a display unit, on the area of the screen through an input operation by a user, as is well known.

Although not shown in the drawings, each of the update management server 11, the electronic apparatus 12, and the PC 13 includes well-known hardware implementing a computer connectable to the network 14 such as a CPU (Central Processing Unit), a ROM (Read Only Memory), a RAM (Random Access Memory), and a network interface. Each of the update management server 11 and the PC 13 generally includes an auxiliary storage device such as an HDD (Hard Disk Drive). The electronic apparatus 12 may include hardware such as an MPU (Micro Processing Unit), a DSP (Digital Signal Processor), an FPGA (Field Programmable Gate Array), or an ASIC (Application Specific Integrated Circuit) in place of a CPU.

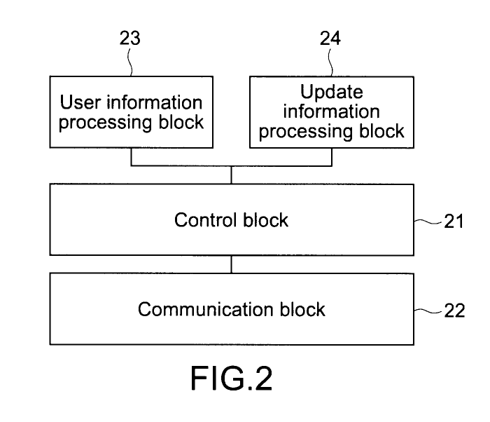

FIG. 2 is a diagram showing a functional block of the update management server 11. The update management server 11 includes a control block 21, a communication block 22, a user information processing block 23, and an update information processing block 24.

The control block 21 functions to control the entire flow of an update processing of software.

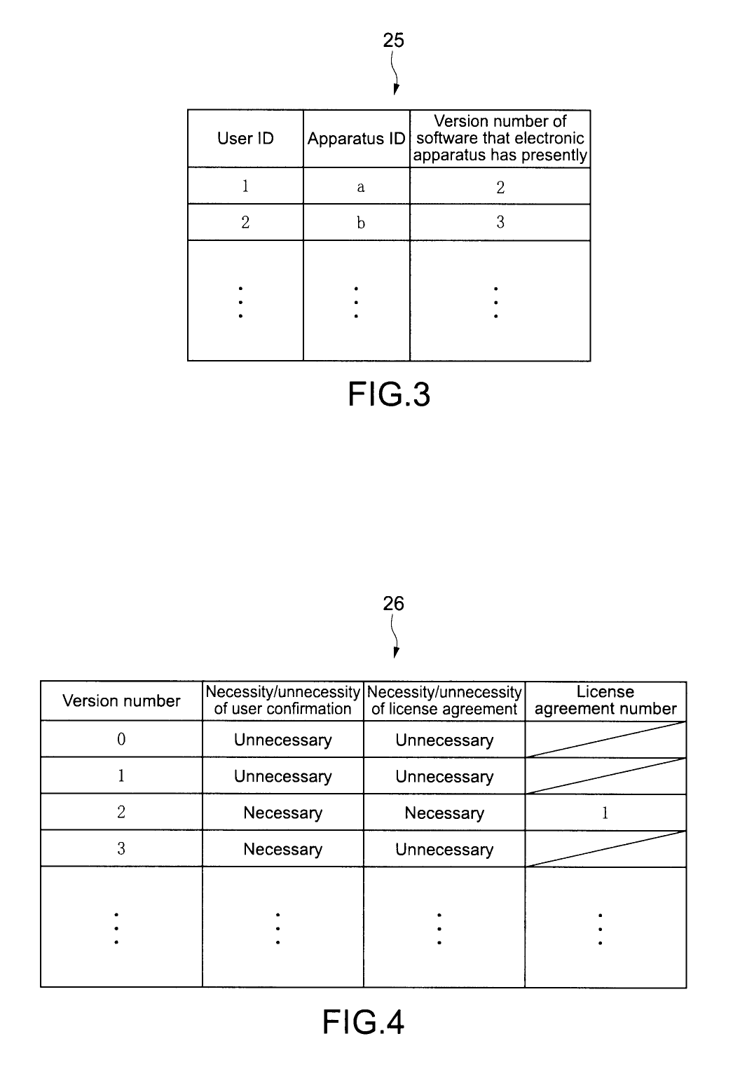

The user information processing block 23 functions to manage information on a user, unique identification information on a user (registration information and the like), unique identification information on the electronic apparatus 12, and the like. FIG. 3 shows an example of a user information table 25 implementing the user information processing block 23 and stored in a storage device (not shown) of the update management server 11. The storage device stores user IDs being unique identification information on users, apparatus IDs being unique identification information on the electronic apparatuses 12, and version numbers of software that the electronic apparatuses 12 have presently in relation to each other.

The update information processing block 24 functions to manage software provided to the electronic apparatus 12, to manage its update, and the like. For example, the update information processing block 24 manages a version number of the software, necessity/unnecessity of confirmation of update of the software with a user, necessity/unnecessity of requirement of a license agreement for the software of a user (whether the software is a target requiring a license agreement), and the like. Further, in a case where the software requires a license agreement of a user, the update information processing block 24 also manages the license agreement (information on contents of license agreement).

The control block 21 functions as a controller and the update information processing block 24 functions as a determining section.

FIG. 4 shows an example of an update information table 26 implementing the update information processing block 24 and stored in a storage device of the update management server 11. The storage device stores version numbers of software, necessity/unnecessity of confirmation of update of software with a user, necessity/unnecessity of requiring a license agreement for software of a user, and license agreement numbers in relation to each other.

Further, the storage device of the update management server 11 stores software corresponding to each version number and a license agreement corresponding to each license agreement number. As a matter of course, the storage device in this case may be different from the storage device storing the above-mentioned table.

The communication block 22 functions to communicate with the electronic apparatus 12 and the PC 13 via the network 14. The communication block 22 functions as a communication section (transmitter and receiver).

(Operation of Update Management System)

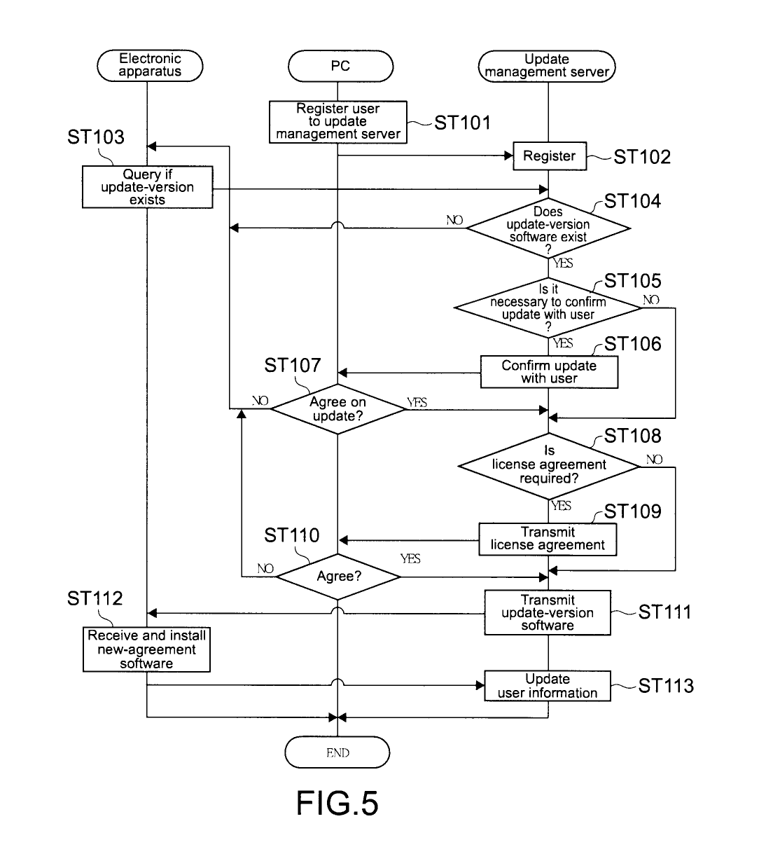

An operation of the update management system 100 structured as described above will be described. FIG. 5 is a flowchart showing the operation.

A user purchases the electronic apparatus 12, agrees on a license agreement for software packaged when he purchased the electronic apparatus 12, and starts to use the electronic apparatus 12. First, the user signs up for a user registration of the electronic apparatus 12 by using the PC 13 (Step 101). Information on the user registration at least includes information uniquely identifying a user (the above-mentioned user ID) and unique identification information on the electronic apparatus 12 (the above-mentioned apparatus ID). Therefore, the update management server 11 makes the user ID, the apparatus ID, and a version number of the present software in relation to each other as shown in FIG. 3 (Step 102). The version number of the present software may be the previously-determined first version number in the user registration. The number may be, for example, a version number of software installed as default when the user purchased the electronic apparatus 12.

After the user registration, in a state where the electronic apparatus 12 is connected to the network 14, the electronic apparatus 12 queries the update management server 11 to confirm if update-version software of the software that the electronic apparatus 12 has presently exists or not (Step 103). The update confirmation is performed periodically. Here, the electronic apparatus 12 transmits its apparatus ID to the update management server 11.

Not limited to a mode in which the electronic apparatus 12 performs update confirmation, the PC 13 that a user uses may perform update confirmation with respect to the update management server 11. Alternatively, in a case where the update management server 11 has update-version software, the update management server 11 may simultaneously transmit information on that to the electronic apparatus 12 (and other electronic apparatuses 12 same as the electronic apparatus 12).

In a case where update-version software exists (YES in Step 104), the update management server 11 determines whether it is necessary to confirm its update with a user based on the update information table 26 (see FIG. 4) (Step 105). Update of software of the electronic apparatus 12 may be performed without performing confirmation with a user depending on kinds of software.

Update-target software being upper-level software such as application or the like may require confirmation with a user.

Determination whether update-version software exists or not may be performed as follows. That is, the update management server 11 refers to the user information table 25 and the update information table 26, and compares a version number of software that the electronic apparatus 12 has presently and a version number of software stored in the update management server 11 (for example, update-version software) to determine. In a case where the version number of software that the electronic apparatus 12 has presently is previous to the version number of update-version software, a state where update-version software may be provided to the electronic apparatus 12 is established.

In a case where it is necessary to confirm update in Step 105, the update management server 11 transmits information on that, information on update contents, and the like to the PC 13 (Step 106). The information on update contents is, for example, information informing that the update-version software is a corrected program of part of older-version software.

A user agrees on update by using the PC 13 (YES in Step 107). Note that, in a case where a user refuses the update (No in Step 107), the flow returns to Step 103, and after that, the electronic apparatus 12 periodically confirms whether to perform update of software of another version or not.

In a case where a user confirms (agrees on) update, the update management server 11 determines whether software of this version is software requiring a license agreement of a user or not based on the update information table 26 (Step 108). The software requiring a license agreement of a user is software requiring a license agreement including contents beyond the scope of license agreement contents of the previous-version software. Hereinafter, such software is referred to as new-agreement software.

In a case where update-version software is new-agreement software, the update management server 11 extracts a license agreement for the new-agreement software based on the update information table 26, and transmits it to the PC 13 of the user to present (Step 109). In this case, the update management server 11 may, for example, transmit email including confirmation requirement of a license agreement.

In Step 108, in a case where the update-version software is software within the scope of the previous license agreement (including license agreement packaged when it was purchased.) (software requiring no license agreement), the update management server 11 proceeds to Step 111.

The PC 13 used by a user may receive and confirm content information on a license agreement. As described above, in the case where the PC 13 used by a user receives a license agreement, typically, by inputting a user ID registered in the update management server 11 (by inputting a password also) into the PC 13 by a user, the update management server 11 may recognize the PC 13 of the user based on the user information table 25. A user ID and a password may be determined in the above-mentioned Step 101.

In a case where a user agrees on contents of the license agreement by using the PC 13 (YES in Step 110), the update management server 11 transmits the new-agreement software to the electronic apparatus 12 (Step 111). For example, a user agrees on a license agreement by performing an action using the PC 13 such as a click on an agreement button or the like displayed on the display unit, and the PC 13 transmits a signal representing an agreement to the update management server 11. Note that, in a case of the above-mentioned confirmation requirement of a license agreement using mail, when the update management server 11 receives reply mail to the mail from the PC 13 of the user, the update management server 11 may perform processing for establishment of a license agreement.

When the electronic apparatus 12 downloads the new-agreement software, the electronic apparatus 12 installs the new-agreement software, to thereby update older-version software (Step 112). In this case, each of a CPU and a program to install the new-agreement software of the electronic apparatus 12 functions as an install unit.

For example, when the electronic apparatus 12 completes the installation, the electronic apparatus 12 notifies the update management server 11 of the completion. Then, the update management server 11 updates the user information table 25 (Step 113). That is, the update management server 11 rewrites a version number of software of the electronic apparatus 12 in the user information table 25.

As described above, according to this embodiment, software requiring a license agreement including contents beyond the scope of a previous license agreement may be provided to an electronic apparatus merely having a simple display unit without causing problems in agreement.

Further, in a case where software to be updated is software requiring a license agreement within the scope of the previous license agreement, the update management server 11 may transmit the software to the electronic apparatus 12, whereby the electronic apparatus 12 automatically updates the software without a license agreement.

### Second Embodiment

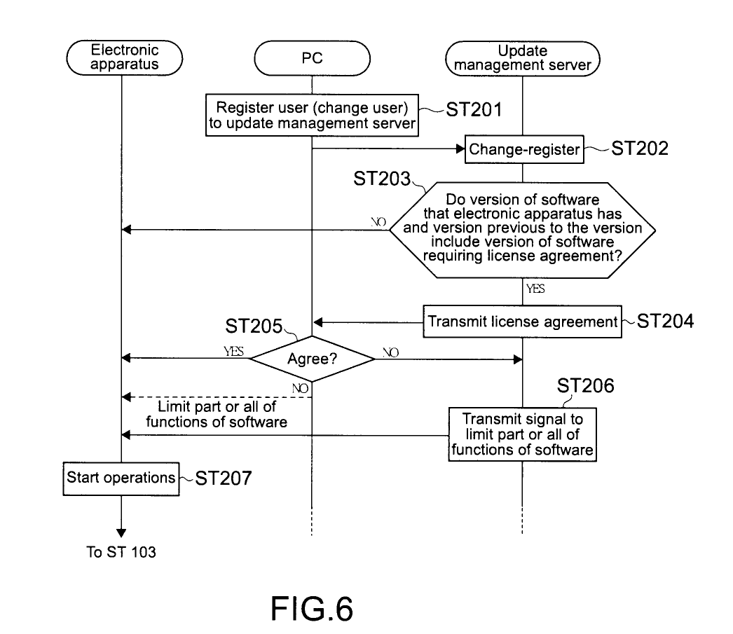

FIG. 6 is a flowchart showing an operation of the update management system 100 according to a second embodiment. The structure of the update management system 100 is similar to the above-mentioned structure.

The operation of this embodiment relates to a case where a user of the electronic apparatus 12 is changed.

For example, after a user hands over the electronic apparatus 12 to another user, the other user (hereinafter, simply referred to as user.) signs up for a user-change registration to the update management server 11 by using the PC 13 owned by the user (Step 201). In this case, the update management server 11 (or user) determines a user ID and a password, and updates the user information table 25 (Step 202). That is, a previous user is rewritten to a new user.

The update management server 11 determines whether a software version of software that the electronic apparatus has presently and a version previous to the version include a version of software requiring a license agreement (new-agreement software) based on the updated user information table 25 (Step 203).

In a case of YES in Step 203, the update management server 11 transmits a license agreement for the new-agreement software to the PC 13 (Step 204). In a case where a plurality of pieces of new-agreement software exist, that is, in a case where new-agreement software has been installed into the electronic apparatus 12 a plurality of times in the past by a previous user, the update management server 11 transmits a license agreement for each new-agreement software.

Alternatively, the update management server 11 may transmit one latest license agreement. Contents of the latest license agreement may sometimes include contents of a previous license agreement.

In a case where a user confirms and agrees on contents of the license agreement by using the PC 13 (YES in Step 205), the user may start to use the electronic apparatus 12 (Step 207). In other words, the electronic apparatus 12 starts operations. In a case where a user does not agree (NO in Step 205), the update management server 11 transmits a signal to limit part or all of the functions of the software to the electronic apparatus 12 (Step 206).

Functions to be limited depend on update contents of the software. Processing to limit functions is, for example, to set a program module of the software a flag for limitation and the like, but is not limited to this. Alternatively, for example, in a case where the latest-version software is not updated, the update management server 11 may transmit a signal to downgrade to previous software.

In a case where a plurality of pieces of previous new-agreement software exist and where a plurality of license agreements corresponding to them exist, according to establishment/nonestablishment of the license agreements, use of software corresponding to them may be limited.

In Step 205, for example, in a case where the PC 13 is communicatably connected to the electronic apparatus 12 by a well-known device, the following processing may be performed. For example, in a case of NO in Step 205, the PC 13 may perform processing to limit part or all of the functions of the software of the electronic apparatus 12.

In the past, a license agreement for software embedded in an electronic apparatus of a user was performed only of the user. So, in a case of ownership change, there was a fear that problems in agreement might occur when the latest user used the software after the ownership change. However, according to this embodiment, in a case of ownership change of a user of the electronic apparatus 12, in a case where new-agreement software requiring a license agreement was installed into the electronic apparatus 12 before the ownership change, the license agreement may be required of a user after the ownership change. Therefore, even in a case where an owner of the electronic apparatus 12 is changed, there is no fear that problems in agreement occur.

### Other Embodiments

Embodiments according to the present disclosure are not limited to the above-described embodiments, and other various embodiments may be implemented.

Other examples of a portable electronic apparatus merely having a simple display unit include measurement apparatuses (for example, stopwatch, thermometer, and other measurement apparatuses), portable music players, peripheral equipments of the PC 13, toys, and the like. Further, examples of an electronic apparatus merely having a simple display unit are not limited to portable apparatuses, but include fixed or mount type apparatuses such as audio devices, washing machines, refrigerators, other home electronic appliances, and the like.

Examples of an electronic apparatus having no display unit include peripheral equipments of PCs, toys, the above-mentioned home electronic appliances, and the like.

The above-mentioned update management server 11 may be implemented by one computer or a plurality of apparatuses. In a case where the update management server 11 is implemented by a plurality of apparatuses, one of those apparatuses may be an apparatus mainly implementing one function such as a storage device, a communication apparatus, or the like.

The PC 13 has been described as an example of an apparatus having a display unit capable of displaying information such as license agreement and the like enough.

Not limited to this, such an apparatus may be a mobile phone or another portable apparatus, for example. Further, not limited to a portable apparatus, such an apparatus may be a fixed or mount type apparatus.

The electronic apparatus 12 may transmit version information on software that the electronic apparatus 12 has presently to the update management server 11. The transmitting timing may be, for example, the timing of Step 103. In this case, the update management server 11 may compare a received present version number of the electronic apparatus 12 with version information on the latest software, to thereby perform determination. As described above, by transmitting version information from the electronic apparatus 12 side, it is not necessary for the update management server 11 side to manage version information on each electronic apparatus 12 (each user).

In other words, in FIG. 3, it is not necessary for the update management server 11 to manage a version number of software that the electronic apparatus 12 has presently.

The present disclosure contains subject matter related to that disclosed in Japanese Priority Patent Application JP 2010-131385 filed in the Japan Patent Office on Jun. 8, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An update management server, comprising:
a storage configured
to store apparatus identification information uniquely identifying a first electronic apparatus failing to have specifications enough to display contents of a license agreement for new-agreement software, the new-agreement software being update-version software of software that the first electronic apparatus has and being target software requiring the license agreement of a user of the first electronic apparatus, version information on the software that the first electronic apparatus has, and user identification information uniquely identifying the user in relation to each other, and
to store the new-agreement software and content information on the license agreement for the new-agreement software in relation to each other;
a communication section capable of receiving the apparatus identification information on the first electronic apparatus via a network;
a first determining section configured to determine whether the version corresponding to the received apparatus identification information is a version previous to the new-agreement software; and
a controller configured
to cause the communication section to transmit, in a case where the first determining section determines that the version corresponding to the apparatus identification information is a version previous to a version of the new-agreement software, content information on the license agreement corresponding to the new-agreement software to a second electronic apparatus owned by the user who owns the first electronic apparatus, the second electronic apparatus having specifications enough to display contents of the license agreement and being connectable to the network, based on the user identification information corresponding to the apparatus identification information, and
to cause the communication section to transmit, in a case where the license agreement establishes, the new-agreement software to the first electronic apparatus having the received apparatus identification information.

2. The update management server according to claim 1, further comprising:
a second determining section configured to determine whether contents of a license agreement for the update-version software are within the scope of contents of a license agreement for software of the version corresponding to the apparatus identification information received by the communication section,
wherein the controller is configured to cause the communication section to transmit, in a case where the second determining section determines that contents of a license agreement for the update-version software are within the scope of contents of a license agreement for software of the version corresponding to the apparatus identification information, the update-version software without a license agreement to the first electronic apparatus.

3. The update management server according to claim 1, further comprising:
an update section configured to update, in a case where an owner of the first electronic apparatus is changed from the user to another user, the user information,
wherein the first determining section is configured to determine, in a case where the communication section receives the apparatus identification information after the update section updates the user information, whether the version corresponding to the received apparatus identification information and a version previous to the version include a version of the new-agreement software being a target requiring the license agreement, and
wherein the controller is configured
to cause the communication section to transmit, in a case where the first determining section determines that a version corresponding to the apparatus identification information and a version previous to the version include a version of the new-agreement software, content information on the license agreement relating to at least one piece of the new-agreement software of software of the version corresponding to the apparatus identification information and the previous version to a third electronic apparatus owned by the other user, the third electronic apparatus having specifications enough
to display contents of the license agreement and being connectable to the network, based on the user identification information on the other user corresponding to the apparatus identification information, and
to cause the communication section to transmit, in a case where the transmitted license agreement fails to establish, a signal limiting functions of the new-agreement software of the license agreement failed to establish to the third electronic apparatus.

4. An electronic apparatus failing to have specifications enough to display contents of a license agreement for new-agreement software, the new-agreement software being update-version software of software that the electronic apparatus has and being target software requiring the license agreement of a user of the electronic apparatus, the electronic apparatus being connectable to a network, comprising:
a transmitter configured to transmit, to an update management server including a storage configured to store apparatus identification information uniquely identifying the electronic apparatus, version information on software that the electronic apparatus has, and user identification information identifying the user who owns the electronic apparatus in relation to each other, and to store the new-agreement software and content information on the license agreement for the new-agreement software in relation to each other, the apparatus identification information on the electronic apparatus via the network;
a receiver configured to receive, in a case where the update management server determines that the version corresponding to the apparatus identification information received by the update management server is a version previous to the new-agreement software and where the update management server transmits content information on the license agreement corresponding to the new-agreement software, via the network, to another electronic apparatus owned by the user who owns the electronic apparatus, the other electronic apparatus having specifications enough to display contents of the license agreement and being connectable to the network, based on the user identification information corresponding to the apparatus identification information, and the license agreement establishes, the new-agreement software transmitted by the update management server via the network; and
an install unit configured to install the new-agreement software received by the receiver on the electronic apparatus.

5. The electronic apparatus according to claim 4,
wherein the electronic apparatus fails to include a display unit.

6. An update management system, comprising:
a first electronic apparatus failing to have specifications enough to display contents of a license agreement for new-agreement software, the new-agreement software being update-version software of software that the first electronic apparatus has and being target software requiring the license agreement of a user of the first electronic apparatus;
a second electronic apparatus owned by the user who owns the first electronic apparatus, the second electronic apparatus having specifications enough to display contents of the license agreement and being connectable to a network; and
an update management server including
a storage configured
to store apparatus identification information uniquely identifying the first electronic apparatus, version information on the software that the first electronic apparatus has, and user identification information uniquely identifying the user who owns the first electronic apparatus in relation to each other, and
to store the new-agreement software and content information on the license agreement for the new-agreement software in relation to each other,
a communication section capable of receiving the apparatus identification information on the first electronic apparatus via the network,
a first determining section configured to determine whether the version corresponding to the received apparatus identification information is a version previous to the new-agreement software, and
a controller configured
to cause the communication section to transmit, in a case where the first determining section determines that the version corresponding to the apparatus identification information is a version previous to a version of the new-agreement software, content information on the license agreement corresponding to the new-agreement software to the second electronic apparatus based on the user identification information corresponding to the apparatus identification information, and
to cause the communication section to transmit, in a case where the license agreement establishes, the new-agreement software to the first electronic apparatus having the received apparatus identification information.

7. An update management method by an update management server, comprising:
storing apparatus identification information uniquely identifying a first electronic apparatus failing to have specifications enough to display contents of a license agreement for new-agreement software, the new-agreement software being update-version software of software that the first electronic apparatus has and being target software requiring the license agreement of a user of the first electronic apparatus, version information on the software that the first electronic apparatus has, and user identification information uniquely identifying the user in relation to each other;
storing the new-agreement software and content information on the license agreement for the new-agreement software in relation to each other;
receiving the apparatus identification information on the first electronic apparatus via a network;
determining, by a determining section, whether the version corresponding to the received apparatus identification information is a version previous to the new-agreement software;
transmitting, in a case where the determining section determines that the version corresponding to the apparatus identification information is one of a version corresponding to the apparatus identification information and a version previous to the version, content information on the license agreement corresponding to the new-agreement software, via the network, to a second electronic apparatus owned by the user who owns the first electronic apparatus, the second electronic apparatus having specifications enough to display contents of the license agreement and being connectable to the network, based on the user identification information corresponding to the apparatus identification information; and
transmitting, in a case where the license agreement establishes, the new-agreement software to the first electronic apparatus having the received apparatus identification information via the network.

8. An update management server, comprising:
a storage configured to store user information in which apparatus identification information uniquely identifying a first electronic apparatus failing to have specifications enough to display contents of a license agreement for new-agreement software, the new-agreement software being update-version software of software that the first electronic apparatus has and being target software requiring the license agreement of a user of the first electronic apparatus, version information on the software that the first electronic apparatus has, and user identification information uniquely identifying the user are in relation to each other;
an update section configured to update, in a case where an owner of the first electronic apparatus is changed from the user to another user, the user information;
a communication section capable of receiving the apparatus identification information on the first electronic apparatus via a network;
a determining section configured to determine, in a case where the communication section receives the apparatus identification information after the update section updates the user information, whether the version corresponding to the received apparatus identification information and a version previous to the version include a version of the new-agreement software being a target requiring the license agreement; and
a controller configured
to cause the communication section to transmit, in a case where the determining section determines that a version corresponding to the apparatus identification information and a version previous to the version include a version of the new-agreement software, content information on the license agreement relating to at least one piece of the new-agreement software of software of the version corresponding to the apparatus identification information and the previous version to a second electronic apparatus owned by the other user, the second electronic apparatus having specifications enough to display contents of the license agreement and being connectable to the network, based on the user identification information on the other user corresponding to the apparatus identification information, and
to cause the communication section to transmit, in a case where the transmitted license agreement fails to establish, a signal limiting functions of the new-agreement software of the license agreement failed to establish to the first electronic apparatus.
